(19) United States
(12) Patent Application Publication
(10) Pub. No.: US 2011/0233339 A1
(43) Pub. Date: Sep. 29, 2011

(54) PASSENGER SEAT ASSEMBLY AND ASSOCIATED FLOOR PANEL STRUCTURE

(75) Inventors: Tommy George Plant, Winston-Salem, NC (US); John W. Maynor, JR., Double Oak, TX (US); Timothy Pahls, Lake Stevens, WA (US)

(73) Assignee: BE Aerospace, Inc., Wellington, FL (US)

(21) Appl. No.: 13/069,474

(22) Filed: Mar. 23, 2011

Related U.S. Application Data
(60) Provisional application No. 61/316,531, filed on Mar. 23, 2010.

(51) Int. Cl. B64C 1/00; B64C 1/18; B64D 11/06; B23P 11/00

(52) U.S. Cl. 244/131; 29/428

(57) ABSTRACT

A system is provided, including at least one floor panel adapted to matingly engage and be supported by a support structure; and securing means for securing at least one seat support to the floor panel; wherein the seat support corresponds to a vertical plane at a substantially horizontal end of at least one seat.

### CROSS REFERENCE TO RELATED APPLICATIONS

This application claims priority to copending U.S. Provisional Patent Application No. 61/316,531, filed on Mar. 23, 2010, which is hereby incorporated by reference in its entirety for all purposes.

### TECHNICAL FIELD AND SUMMARY

The present example embodiments relates generally to the field of aircraft passenger seat assemblies, and more particularly, to a passenger seat assembly and associated composite floor panels that replace the existing floor panels, attach to the existing aircraft floor structure, and integrate new/additional seat tracks at locations different from the original aircraft seat tracks.

Conventional passenger seat assemblies typically include seat frames whose structure is dictated by the locations of the existing seat tracks of the original floor panels. This design limitation restricts the available geometry of the seat frame and the attachment points to the aircraft structure, resulting in added weight, complexity and cost. U.S. Pat. Nos. 7,029,215 and 7,261,378 are illustrative of such devices.

The U.S. Pat. No. 7,029,215 discloses and claims a track fastener assembly for securing a seat or cargo apparatus to a floor track of a vehicle. The assembly includes a bottom rail with forward and aft ends. Front and rear movable slides carrying locking studs are carried by the bottom rail. A locking rod having a helical groove formed in its outer surface is operatively connected to the bottom rail and the slides. Rotation of the locking rod causes the slides to move axially from an installation position to a locking position. As the slides move to the locking position, they are deflected upwards along with the attached locking studs, clamping the track fastener assembly to the track.

The U.S. Pat. No. 7,261,378 discloses and claims a locking apparatus for a moveable component of an aircraft seat. The locking apparatus includes a housing for being slidably received in a track, a first pair of opposed cams pivotally mounted in the housing, and a release member. The cams are moved between a lock position where the cams prevent the housing from sliding within the track and a release position. The release member is selectively moveable between a first position where the cams are maintained in the lock position and a second position where the cams are maintained in the release position.

Structures such as described in the above-referenced patents and many others utilize the pre-installed tracks of the aircraft exclusively. However, evolutionary developments in aircraft seat design, spacing and accessories often utilize areas under the seat bottom for mounting electronic and seat support components. In addition, increased rigidity to the entire seating structure can be enhanced by providing attachment points customized to the leg structure of a particular seating structure as opposed to altering the geometry of a seat leg structure to fit a preinstalled track geometry. These structural design limitations restrict the geometry of the seat frame and obstruct the valuable storage space beneath the seats, resulting in added weight, complexity, cost and decreased rigidity.

Accordingly, Applicants have found that it would be desirable to provide a seat frame having a lightweight design and overall geometry that exploits the available cabin space, as well as an associated floor panel structure including seat tracks located to accommodate the seat frame, resulting in an overall lightweight, simple and cost saving design.

According to an example embodiment, a system is provided, comprising at least one floor panel adapted to matingly engage and be supported by a support structure; and securing means for securing at least one seat support to the floor panel; wherein the seat support corresponds to a vertical plane at a substantially horizontal end of at least one seat.

According to another example embodiment, the system comprises at least one pre-existing securing means that does not correspond to a vertical plane at a substantially horizontal end of the at least one seat, and wherein the floor panel is adapted to matingly engage the support structure at a position adjacent to at least one pre-existing securing means.

According to another example embodiment, the system comprises a cover adjacent the at least one floor panel, the cover being adapted to cover the pre-existing securing means.

According to another example embodiment, at least one floor panel comprises a plurality of floor panels extending parallel to the securing means and pre-existing securing means.

According to another example embodiment, the securing means extends at an angle that is not parallel to the pre-existing securing means.

According to another example embodiment, the securing means comprises a track having a plurality of recesses adapted to engage at least one seat support.

According to another example embodiment, the at least one seat support comprises at least one extension for matingly engaging at least one of the plurality of recesses.

According to another example embodiment, the extension comprises a fastener.

According to another example embodiment, the fastener is threaded.

According to another example embodiment, the securing means comprises a track having a longitudinal groove adapted to engage at least one seat support.

According to another example embodiment, the longitudinal groove comprises a plurality of arcuate recesses at least one edge of the groove to engage at least one seat support.

According to another example embodiment, the at least one floor panel comprises a plurality of floor panels extending parallel to the at least one securing means.

According to another example embodiment, a method is provided, comprising: providing at least one floor panel adapted to matingly engage and be supported by a support structure and having securing means for securing at least one seat support to the floor panel; wherein the seat support corresponds to a vertical plane at a substantially horizontal end of at least one seat; and securing at least one seat support to the floor panel via the securing means.

According to another example embodiment, the support structure comprises at least one pre-existing securing means that does not correspond to a vertical plane at a substantially horizontal end of the at least one seat, and wherein the floor panel is adapted to matingly engage the support structure adjacent to at least one pre-existing securing means.

According to another example embodiment, the at least one floor panel comprises a plurality of floor panels extending parallel to the securing means and pre-existing securing means.

According to another example embodiment, the securing means comprises a track having a plurality of recesses adapted to engage at least one seat support.

According to another example embodiment, the at least one seat support comprises at least one extension for matingly engaging at least one of the plurality of recesses and wherein the step of securing includes matingly engaging the at least one extension to the at least one of the plurality of recesses.

### BRIEF DESCRIPTION OF THE DRAWINGS

These and other features, aspects and advantages of the example embodiments are better understood when the following detailed description of the example embodiments is read with reference to the accompanying drawings, in which:

FIG. 1 is a front perspective view of a passenger seat assembly and associated floor panels including seat tracks in accordance with an example embodiment;

FIG. 2 is a front elevation view of the seat assembly of FIG. 1 further illustrating the aircraft floor structure;

FIG. 3 is an isolated front view of the seat assembly and seat tracks;

FIG. 4 is an isolated rear view of the seat assembly and seat tracks;

FIG. 5 is a perspective view of the floor panels illustrating their attachment to the aircraft floor structure;

FIG. 6 is a sectional view of a floor panel and seat track;

FIG. 7 is a detailed view of the rear track fitting;

FIG. 8 is an isolated view of the track fastener of FIG. 7; and

FIG. 9 is a detailed view of the front track fitting.

### DETAILED DESCRIPTION

Example embodiments will now be described more fully hereinafter with reference to the accompanying drawings in which example embodiments are shown. However, other example embodiments may have many different forms and should not be construed as limited to the representative embodiment set forth herein. The example embodiments are provided so that this disclosure will be both thorough and complete, and will fully convey the scope of the example embodiments and enable one of ordinary skill in the art to make, use and practice the example embodiments.

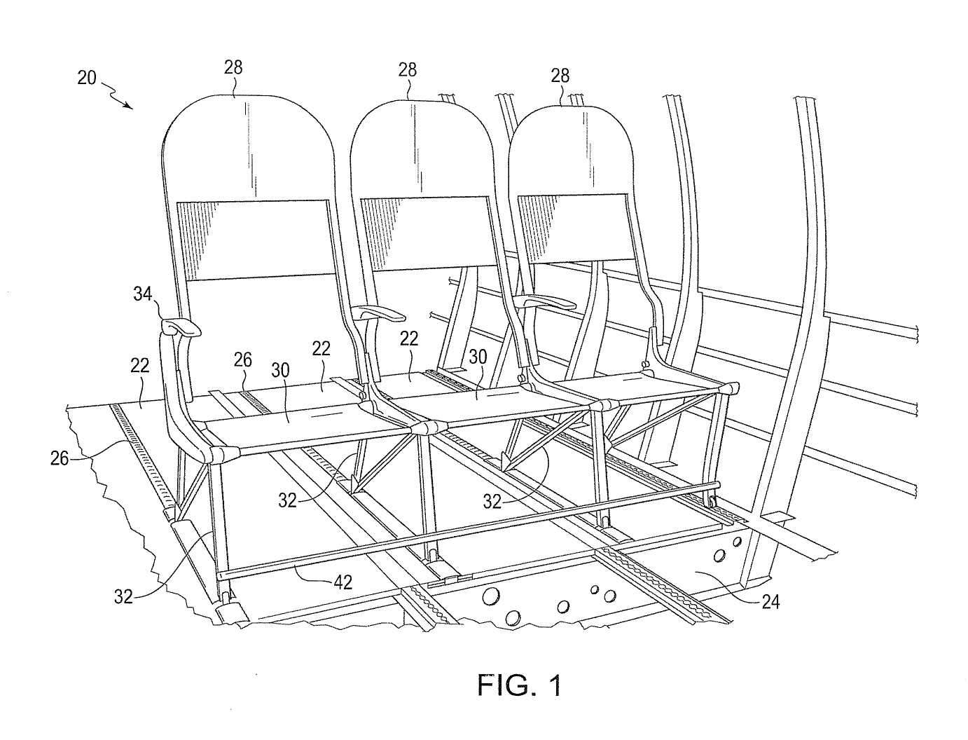

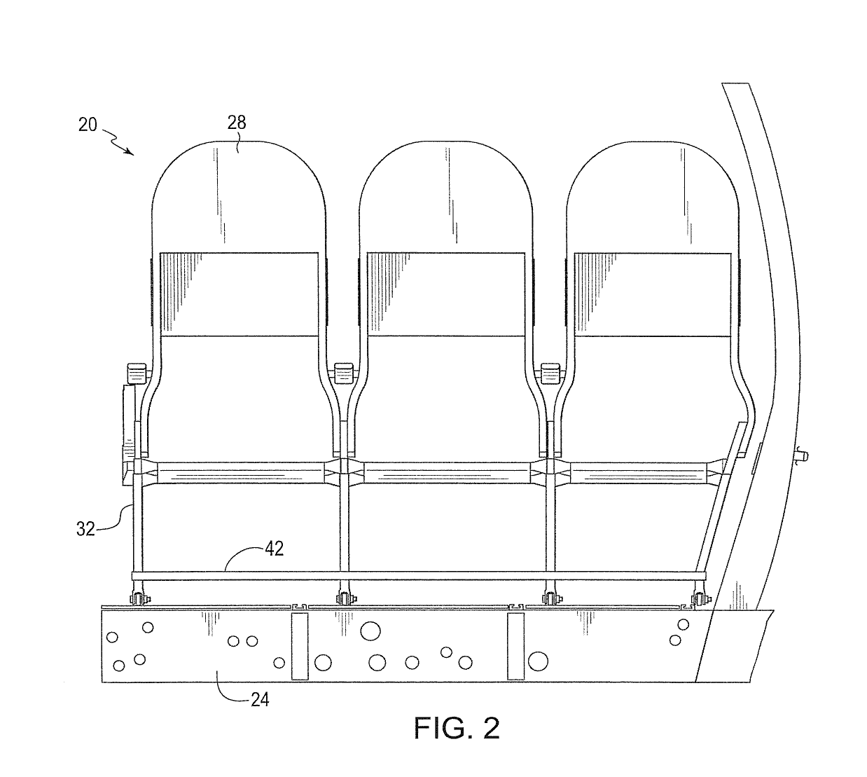

Referring to FIGS. 1 and 2, an aircraft seat assembly and associated floor panels including integrated seat tracks are shown. The example seat assembly 20 is mounted to a plurality of seat tracks 26 or other securing means secured between composite floor panels 22 of floor structure 24. The example seat assembly 20 includes a plurality of seats, each having a seat back 28, seat pan 30 and shared armrests 34. The example seat assembly 20 is supported by a leg assembly 32 which may include a cross member 42 for providing additional structural support.

The seat assembly, shown generally at reference numeral 20, may include three seats supported by a leg assembly 32 having four sets of legs. It is envisioned, however, that the seat assembly may include a greater or lesser number of seats and corresponding number of sets of legs. The seat assembly 20 may be detachably secured to a plurality of underlying floor panels 22 that are secured to the aircraft floor structure 24, replace the original floor panels, and integrate new/additional seat tracks 26 or other securing means at locations different from the original aircraft seat tracks 48. The floor panels 22 may be made from composite materials for strength and weight saving benefits. Seat tracks 26 may comprise a regularly-spaced linear arrangement of circular bores or other openings 64, a linear track having a continuous groove with regularly spaced arcuate grooves for receiving a bolt or other securing member, a combination thereof, or any other suitable modular or non-modular securing means.

As discussed above, seat assembly 20 may include frame portions defining seat backs 28, seat pans 30, supporting leg assembly 32, and armrests 34. Although not shown, it is envisioned that the seat assembly 20 may include additional structural components such as, but not limited to, seat pan length adjusters, leg rests and moveable head rests. Each seat back 28 and seat pan 30 may be spanned with a shell, webbing or other support structure that may be padded and upholstered to provide passenger comfort.

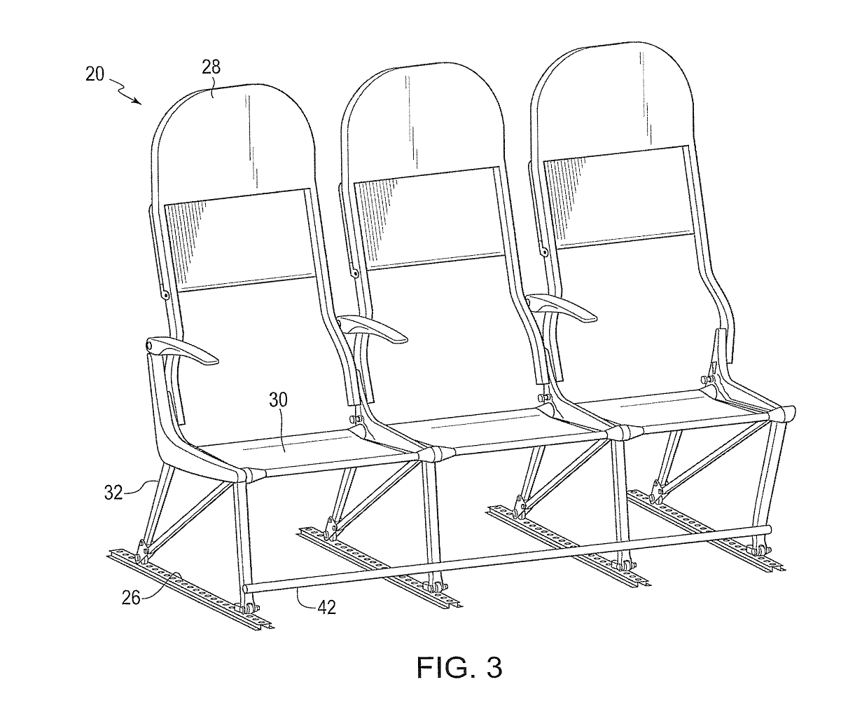

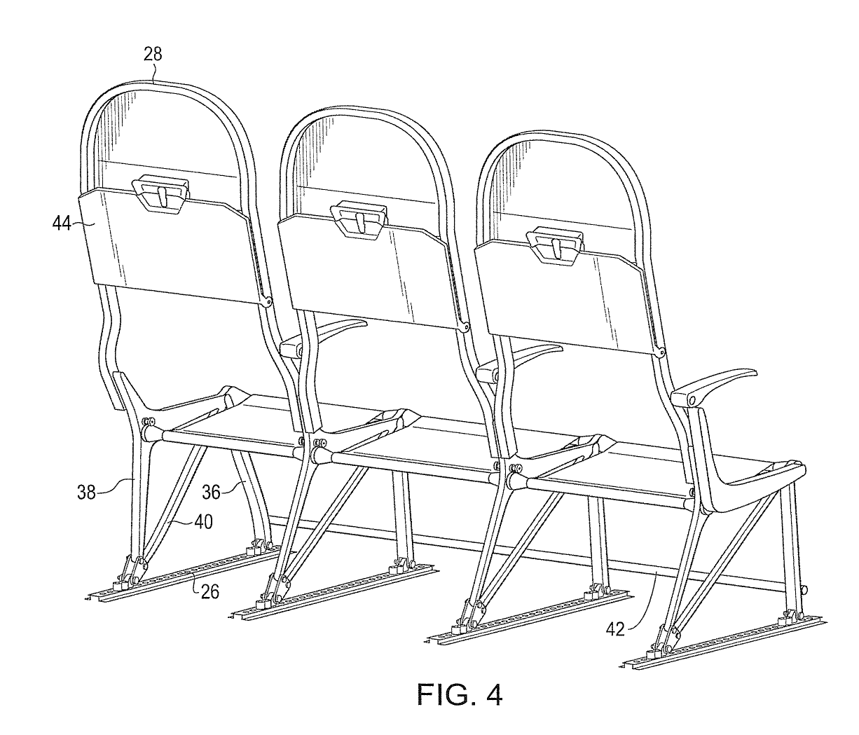

Referring now to FIGS. 3 and 4, an isolated view of the seat assembly 20 and seat tracks 26 of FIGS. 1 and 2 is shown. Each seat pan 30 may be supported from beneath its left and right sides by a leg assembly 32, each of which may include a front leg 36 extending from about the front edge of the seat pan 30 to a position on the seat track 26 forward of the front edge of the seat pan 30, a rear leg 38 extending from about the rear edge of the seat pan 30 to a position rearward of the rear edge of the seat pan 30, and an intermediate leg 40 extending between about the intersection of the front leg 36 and seat pan 30 to about the intersection of the rear leg 38 and the seat track 26, thus at or near a 45 degree angle relative to horizontal. This leg arrangement may form a supportive structure that evenly distributes the weight of the seat and passenger between the front and rear leg/seat track attachment points. The angle and attachment points of leg 40 may function as a cross brace that provides stability to the support structure and prevents the seat pan 30 from movement about its lateral (i.e. left-to-right) axis.

The plurality of front legs 36 of the seat assembly 20 may be interconnected by a generally horizontal cross member 42 that may be positioned slightly elevated and spaced-apart from the underlying floor panels 22, thus serving as a baggage retainer/foot rest for the aft positioned seats as well as a stabilizer which helps prevent lateral movement of the seat assembly. As shown by FIG. 4, each seat back 28 may define an arched top end and supports a selectively deployable tray table assembly 44 for use by the aft-positioned passenger. As known to those skilled in the art, the seat backs 28 may be configured to move between upright and reclined positions for passenger comfort.

Referring to FIG. 5, an isolated view of the floor structure 24 is shown. The example floor structure 24 includes a plurality floor joists 46 supporting a plurality of original seat tracks 48. These original seat tracks 48 may be generally permanently installed and are typically installed at the time of manufacture of the aircraft. The original seat tracks 48 are spaced to accommodate uniform floor panels (not shown). As shown by FIG. 5, the plurality of composite floor panels 22 and seat tracks 26 may be installed in place of or on top of original the floor panels. The composite floor panels 22 may be generally rectangular in shape and include at least one seat track 26 running longitudinally along the length of the panel from end to end, and positioned generally parallel to the longitudinal axis of the aircraft. The number of seat tracks 26 per panel 22 may be dependent upon the span (i.e. width) between original seat tracks 48 on the one hand and on the span between the corresponding positions of the sets of legs of the seat assembly 20 on the other. Panels 22 may be sized and shaped according to the framework of the underlying aircraft floor structure 24. It is envisioned that should the seats be positioned at an angle other than parallel to the longitudinal axis of the aircraft, the seat track positions may be adjusted to accommodate that angle as well. For example, if the seats and/or leg assemblies are configured to face an angle rotated 15 degrees from the longitudinal axis of original seat tracks, each panel may shaped to accommodate such a rotation, for example, by providing a pair of complementary trapezoidal shapes. Each panel 22 may define a generally planar top surface defining the deck of the aircraft that may be carpeted, insulated, further covered, etc., and may include the seat track 26 either flush with, recessed or extending vertically upward therefrom. The panels 22 may be secured to the aircraft structure, such as to the floor joints 46, using, for example, a conventional fastener or other technique common in aircraft construction. Panels 22 arranged along the length of the aircraft may be aligned such that the seat tracks 26 are longitudinally aligned. In the embodiment shown by FIG. 5, the original seat tracks are illustrated at 48, and seat tracks 26 are shown shifted right of the position original seat tracks 48 when viewing the floor structure from the cockpit back.

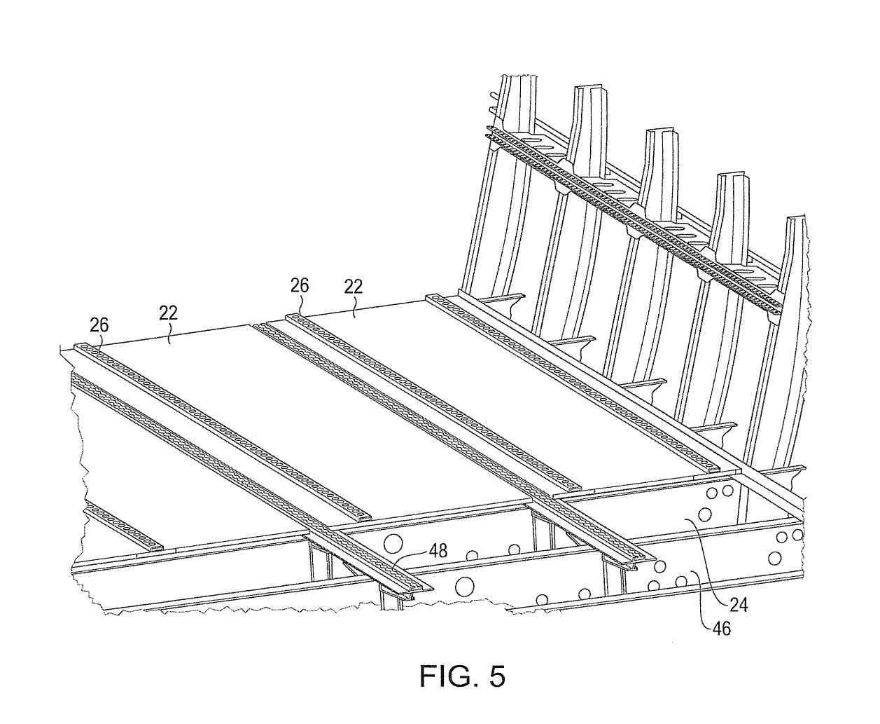

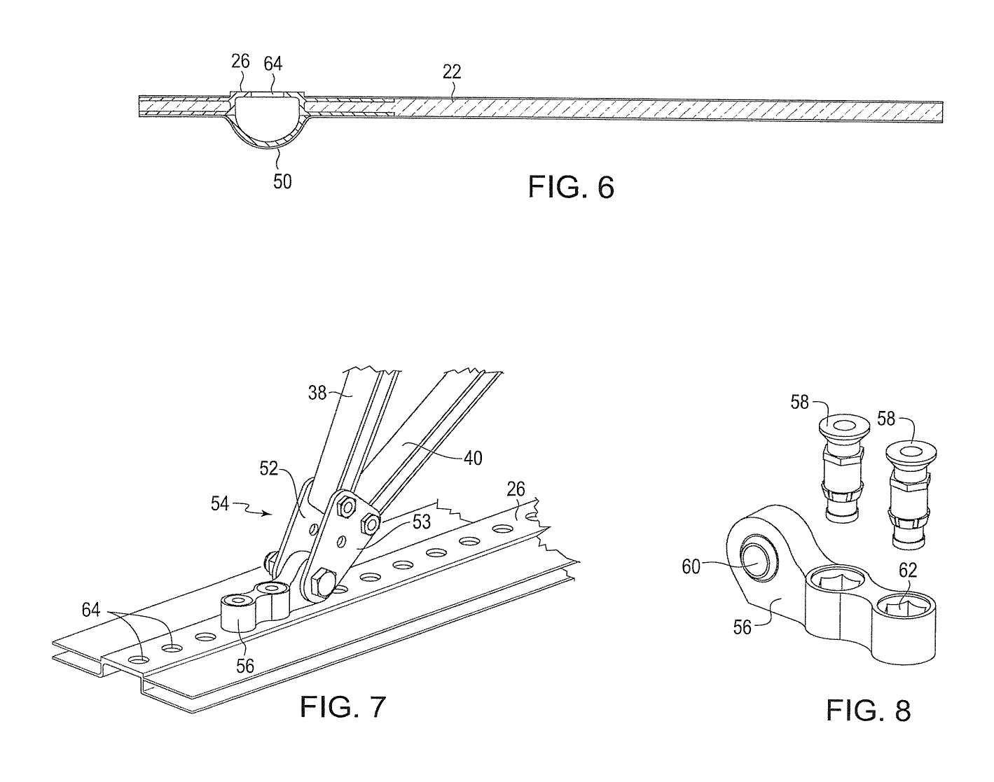

FIG. 6 disclose a sectional view of a panel 22 and seat track 26 taken through the width according to an example embodiment. FIG. 6 reveals that the seat track 26 may extend both above and below the edge of the panel 22. In an embodiment shown by FIG. 6, graphite plies 50 may be used to wrap the seat track extrusion on one or both of the top and bottom surfaces of the seat track 26. These plies 50 may provide additional structural support and protection from sharp exposed edges, and may also provide cosmetic and design benefits.

Referring to FIGS. 7 and 8, the rear track fitting may function to detachably secure the rear and intermediate legs 38, 40 to the seat track 26. The rear and intermediate legs 38, 40 may terminate at and be secured between first ends of opposing plates 52, 53 of a bracket assembly 54. A rear track fastener 56 may be secured at its first end between the second ends of the plates 52, 53 and may define at least one opening therethrough for receiving a fastener 58, such as an E-nut, for securing the rear track fastener 56 to the seat track 26. Pivoting movement of the rear track fastener 56 relative to the bracket assembly 54 may be facilitated by the use of a bearing 60, which allows proper seating of the rear track fastener 56 on the seat track 26. The rear track fastener 56 may include more than one fastener attachment point to provide secure attachment and prevent twisting of the seat assembly 20 relative to the seat track 26. The fasteners 58 may be received through adjacent openings 62 defined through the rear track fastener 56 and engage within appropriate underlying adjacent openings 64 defined through the seat track 26. The fasteners 58 may be configured to require a special, custom or non-standardized tool for insertion/removal to prevent tampering. As shown by FIG. 8, the seat tracks 26 include a plurality of linearly arranged openings 64 spaced apart at equal intervals such that the seat track fastener 56 may be attached at any desired point along the length of the seat track.

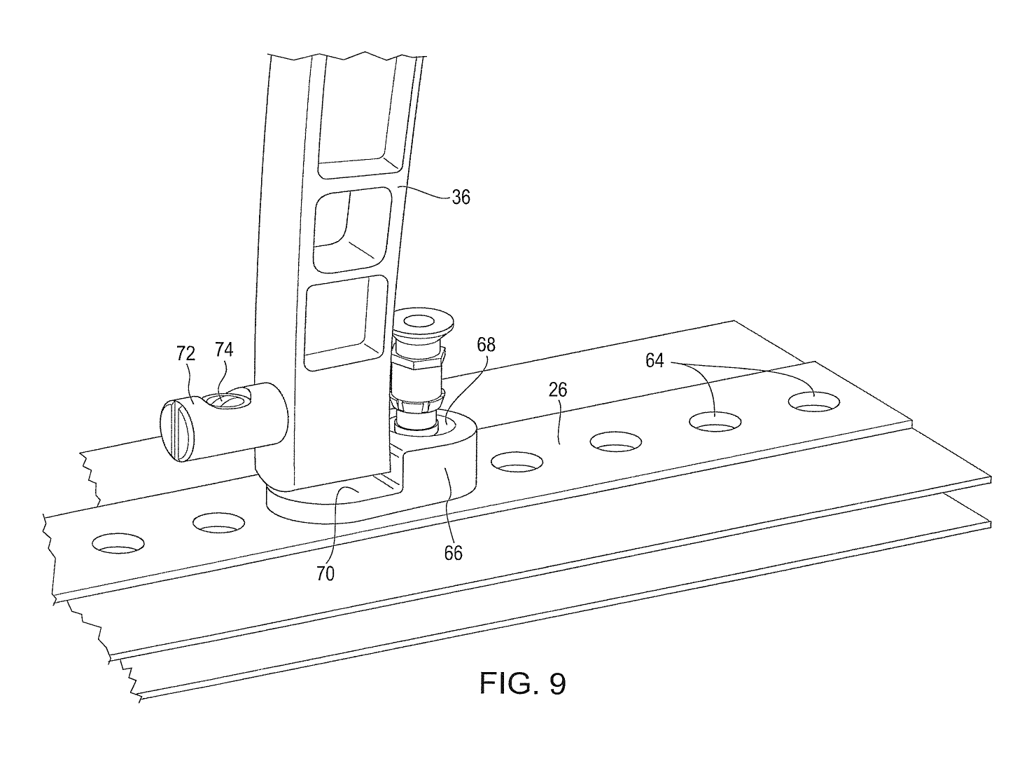

Referring to FIG. 9, the front track fitting functions to detachably secure the front leg 36 to the seat track 26. The front leg 36 may attach to a front track fastener 66 that defines a first opening 68 offset from the leg for receiving a fastener 58 therethrough, such as an E-nut, that may be received within aligned openings defined through the fastener 66 and seat track 26. The front track fastener 66 may further define a flat 70 upon which the front leg 36 seats and is secured to. As shown, the front track fastener 66 may be secured to the front leg 36 by way of a barrel nut 72 defining a threaded opening 74 therethrough that threadably engages a bolt or other fastener. The bolt may be received from beneath the front track fastener 66, through the fastener, through an opening defined in the leg 36, and into engagement with the barrel nut 72. The bolt may further engage an opening in the seat track 26.

While a seat assembly and associated replacement floor panels having seat tracks have been described with reference to specific embodiments and examples, it is envisioned that various details of the example embodiments may be changed without departing from the scope of the example embodiments and claims. Furthermore, the foregoing description of example embodiments and best mode are provided for the purpose of illustration only and not for the purpose of limitation.

What is claimed is:

1. A system comprising:
at least one floor panel adapted to matingly engage and be supported by a support structure; and
securing means for securing at least one seat support to the floor panel; wherein the seat support corresponds to a vertical plane at a substantially horizontal end of at least one seat.

2. The system of claim 1, wherein the support structure comprises at least one pre-existing securing means that does not correspond to a vertical plane at a substantially horizontal end of the at least one seat, and wherein the floor panel is adapted to matingly engage the support structure at a position adjacent to at least one pre-existing securing means.

3. The system of claim 2, further comprising a cover adjacent the at least one floor panel, the cover being adapted to cover the pre-existing securing means.

4. The system of claim 1, wherein the at least one floor panel comprises a plurality of floor panels extending parallel to the securing means and pre-existing securing means.

5. The system of claim 1, wherein the securing means extends at an angle that is not parallel to the pre-existing securing means.

6. The system of claim 1, wherein the securing means comprises a track having a plurality of recesses adapted to engage at least one seat support.

7. The system of claim 6, wherein the at least one seat support comprises at least one extension for matingly engaging at least one of the plurality of recesses.

8. The system of claim 7, wherein the extension comprises a fastener.

9. The system of claim 8 wherein the fastener is threaded.

10. The system of claim 1, wherein the securing means comprises a track having a longitudinal groove adapted to engage at least one seat support.

11. The system of claim 1, wherein the longitudinal groove comprises a plurality of arcuate recesses at least one edge of the groove to engage at least one seat support.

12. The system of claim 1, the at least one floor panel comprises a plurality of floor panels extending parallel to the at least one securing means.

13. A method comprising:
providing at least one floor panel adapted to matingly engage and be supported by a support structure and having securing means for securing at least one seat support to the floor panel; wherein the seat support corresponds to a vertical plane at a substantially horizontal end of at least one seat; and
securing at least one seat support to the floor panel via the securing means.

14. The method of claim 13, wherein the support structure comprises at least one pre-existing securing means that does not correspond to a vertical plane at a substantially horizontal end of the at least one seat, and wherein the floor panel is adapted to matingly engage the support structure adjacent to at least one pre-existing securing means

15. The method of claim 13, wherein the at least one floor panel comprises a plurality of floor panels extending parallel to the securing means and pre-existing securing means.

16. The method of claim 13, wherein the securing means comprises a track having a plurality of recesses adapted to engage at least one seat support.

17. The method of claim 16, wherein the at least one seat support comprises at least one extension for matingly engaging at least one of the plurality of recesses and wherein the step of securing includes matingly engaging the at least one extension to the at least one of the plurality of recesses.

18. The method of claim 17, wherein the extension comprises a fastener.

19. The method of claim 18 wherein the fastener is threaded.

20. The method of claim 13, the at least one floor panel comprises a plurality of floor panels extending parallel to the at least one securing means.
